(19) United States
(12) Patent Application Publication
(10) Pub. No.: US 2019/0371198 A1
(43) Pub. Date: Dec. 5, 2019

(54) MULTIMEDIA SYSTEM WITH HUMAN-MACHINE INTERFACE FOR ADVANCED BARTENDING ACTIVITY

(71) Applicants: Antonello Pascazio, Casamassima (IT); Annalia Notarnicola, Putignano (IT); Vitoantonio Bevilacqua, Noicattaro (IT)

(72) Inventors: Antonello Pascazio, Casamassima (IT); Annalia Notarnicola, Putignano (IT); Vitoantonio Bevilacqua, Noicattaro (IT)

(21) Appl. No.: 16/330,493

(22) PCT Filed: Sep. 8, 2016
(86) PCT No.: PCT/IT2016/000205

§ 371 Date: Mar. 5, 2019

(51) Int. Cl. G09B 19/00; H04R 1/10; G10L 15/22; G09B 5/06; G06N 3/12

(52) U.S. Cl. CPC G09B 19/003; H04R 1/1016; H04R 1/1041; H04R 2420/07; G09B 5/065; G06N 3/126; G10L 2015/223; G10L 15/22

(57) ABSTRACT

A multimedia system for bartender training or on-job supporting is provided, perfectly integrated in a bar work station. It is composed by a personal computer with a screen, an earphone with Bluetooth® technology, a palmtop and an ad-hoc implemented system that is equipped with an independent artificial intelligence based on genetic algorithms. This system takes as input an order composed by different drinks, chosen by the user or casually generated by the software for training or given by palmtop for on-job supporting. The software elaborates the order and this elaboration is shown on the screen together with the operations that the bartender has to do. The earphone also reproduces the operations. After this step, the interaction between the system and the user takes place exclusively using the voice, until the end of the preparation. This invention produces a radical improvement of bartender' speed, efficiency, precision and way of reasoning with a drastic decrease of drink's preparation time.

### 1. TECHNICAL FIELD

The present invention relates to a multimedia system dedicated to the improvement of training quality of a bartender and to the efficiency increase of these working figures within a commercial business. Thus, it is provided a new technique for training bartenders to work at a fast pace, while also maintaining high quality standards of service and final product, minimizing the needed time for drinks' preparation.

There are generally two types of traditional methods for train bartenders. The first method is training in the workplace, supported by the staff working in the business or by the responsible staff for training new recruits. The second method, instead, provide for attendance of specializing training courses, during which the preparation of drinks is simulated in familiar surroundings, supported by skilled professionals. In both cases, preparation procedures are taught to new bartenders and products knowledge is provided to them.

Unfortunately, due to extreme lack of homogeneity among the food and beverage companies, and, moreover, to the not verifiability of the training quality possessed by members already operating in one of these, the first training method results obsolete e forces bartender to renew and conform his knowledge whenever he changes job. The second method is, instead, still extremely effective, since in the training courses standardized notions, preparation techniques and work methods are provided to participants. To date, bartenders of greater depth at the international level usually contribute to training schools and sponsors for the new professionals training. However, the requirement of experience on workplace remains essential to ensure a bartender to become efficient, rapid, accurate and performing from a commercial point of view. These qualities, which provide also an improvement of mental and physical qualities of a human, are not, to date, are not obtainable from any training course at worldwide level. The mind evolution of a human depends, first, on its character, but also on training provided to its mind. In conclusion, it takes years to reach high level of performance, regardless of quality of possessed education.

At the same time, also the most skilled bartender can have an attention drop or a phase of fatigue related to work or not causes.

The present invention has the purpose of provide that mental education that only the knowledge-experience couple can provide, until now. This objective was achieved by inserting, for the first time, an independent artificial intelligence through a multimedia system within a bar station, situated whether inside to a training school or to a commercial local. This new apparatus is able to provide extremely precise and detailed informations in record time and, at the same time, to shape the operator's way of reasoning.

### 2. BACKGROUND ART

To date, numerous tools and devices have been developed with the purpose of provide training for a bartender. Some of them date back to decades ago, and they are even now used.

These tools focus individually on the bartender precision, his speed or his ability to remember the recipes. Technological tools used for the bartender training are very few.

The only technological tool for bartender training is the U.S. Patent Publication No. 2014/0242558 to Daragjati, which discloses a bartender training method and apparatus, dedicated to improvement of bartender abilities. It is composed by a bar workstation with annexed slop bin, in which throw drinks after their preparation, and a display screen on which drinks preparation methodologies and recipes are displayed. The Daragjati's method introduced a technological device inside a bar workstation and this method is approached to the bartender speed and efficiency. However, the Daragjati's invention shows some weakness.

The touchscreen system provides exclusively informations about ingredients and methods of administration, working with discrete complexity orders. The difficulty level is increased by masking these informations. This system results to be extremely static, useful only to provide informations, without a previous elaboration. The present invention provides an elaborated information by an independent artificial intelligence, which does not mask any information, but provides the best procedure for the preparation of many drinks, using pouring and preparation techniques internationally recognized. The training happens in two ways: the bartender exercises with these techniques and at the same time he gradually stores these informations in his mind and his cultural baggage merely observing how the independent artificial intelligence thinks.

The real presence of an independent artificial intelligence inside the multimedia system is highlighted by the discordance of software elaboration results on an identical drink order. This situation is intrinsic in the mixology concept, in fact, using the same standardized pouring and preparation techniques, the efficient ways to complete the drink order are multiple. During the application of this invention, the bartender is followed by a thinking mind and he perceives its presence in each obtained elaboration. In this way, the bartender mind is driven to think in the same manner of the software, until to become independent from it. In that moment, it will be sufficient for him to observe the order to find the operations to perform. The Daragjati's method, instead, does not work in no way on the bartender mind, but only on his mechanical and repetitive movements, making in closing the bartender a robot, without effective ability to react to external stimulations. Any different situation from those provided in the muffled environment of the training will drive the bartender into a disorientation and uncertainty condition, where he will search desperately for a solution that a static system cannot provide to him.

The condition of use of the present invention is based on the application of a screen and a Bluetooth® earphone, which involve a great advantage that is keeping the bartender hands free and available to put into practice what the system prompt to carry out.

The use of vision, hearing and voice improves the bartender work efficiency and his receptive ability, since information are provided to him in different ways. The Daragjati's method expects the human-system interaction through touching a touchscreen that limiting the bartender performance. This is because he will be forced to leave any work tool for interact with the apparatus. The use instead of vision, hearing and voice provides continually to the bartender the freedom to work.

The unquestionable differences between Daraqjati's method and the present invention are now summarized, in order to underline the full innovation of the present invention.

Daraqjati's method discloses a static system based on a tablet that only provides drink's recipes. The present invention discloses an innovative multimedia dynamic system that, in addition of the recipes, provides also pouring techniques, preparation methods and their combinations, right glasses to use, categories of drinks. These informations are obtained by intersecting the recipes of all the drinks those are present in an order and elaborating them using genetic algorithms' criteria.

Daraqjati's method discloses a system that needs the use of the hands in order to interact with it. The present invention instead discloses an innovative system that needs voice, hearing and vision in order to interact with it, freeing the bartender's hands those can be used only for training or for working.

Daraqjati's method provides only for a training on a few drinks, sometimes repeated an with very simple recipes. The present invention instead provides for a new training on a high number and of any kind of drinks, including also the more challenging recipes.

Daraqjati's method provides only a mechanic training of the bartender, working only on his motoric and practical skills. The present invention, in a full innovative way, works on the bartender's way of reasoning and on his ability to elaborate an order, not only on his ability to execute it.

Daraqjati's method has no way to be used during a real working situation. The present invention has instead the innovative possibility to be used in any kind of working situation thanks to its interaction with a palmtop designed for obtain orders to provide them to the system of this invention.

Another device is the CN Patent Publication No. 204440546 to Ling, which discloses a highly technological system able to accomplish in a completely independent manner the same operations that a bartender does, with extremely high results in terms of efficiency, precision and speed. However, the Ling's invention excludes completely the human presence, leading to a decay of the training concept. The aforementioned system has not any commercial prospective, since the human presence of the bartender is essential in a commercial local, limiting the application of this device only as an automatic machine.

The present invention, thus, provides a new method for the bartender training or for support during his work activity. The multimedia system of the present invention can be applied on any bar workstation and used by any operator who wants to improve his own bartender ability, or who needs support during work. The methodologies used in the present invention are totally divergent from the other aforementioned inventions and their underdevelopment is underlined and outclassed by the present invention.

### 3. DISCLOSURE OF INVENTION

In view of the foregoing disadvantages inherent in known types of bartending training methods now present in the prior art, the present invention provides a completely new and unique multimedia system dedicated to high level bartender training and to support the operator during his work activity. The present invention is able to improve the bartender's knowledge, efficiency, speed and precision and simultaneously to educate his mind to an efficient working method, thanks to the interaction with independent artificial intelligence created from scratch.

The purpose of the present invention is to provide a new training and support method for bartender, fully innovative in comparison with all the methods of the prior art, having no one of their disadvantages.

Another purpose of the present invention is to provide a new bartender training or support method based on a unique and innovative bar workstation, equipped with all the tools for drinks' preparation and with a multimedia system made up of a personal computer with flat screen, a Bluetooth® earphone, a palmtop and a specifically created software.

Further purpose of the present invention is to provide a new bartender training or support method based on the human interaction with the independent artificial intelligence of the multimedia system just now described. This independent artificial intelligence has been improved using genetic algorithms, applied thanks to computer engineering to the bartending world.

Another purpose of this present invention is to provide a new bartending training or support method used to teach, through the described multimedia system, methodologies to prepare many drinks simultaneously present in a prearranged or random order, providing drink recipes, efficient arrangement of glasses and tools for the drink preparation, pouring techniques, preparation procedures and precise doses of ingredients. The bartender is followed continuously by the system during all the preparation, until the completion of the order.

Further purpose of the present invention is to provide a new bartender training and support method based on a human-machine interaction that uses exclusively voice, hearing and vision, through a flat screen and a Bluetooth® earphone.

Another purpose of the present invention is to provide a new bartender training and support method that interacts with the skilled bartender during an extremely stressful and demanding working activity phase, receives orders from customers through the room staff palmtops, elaborates orders with the independent artificial intelligence of the multimedia system and drives the bartender in a continuous manner until the completion of the drinks order.

Further purpose of the present invention is to provide a new bartender training and support method implementable worldwide and usable by any operator who wants improve his own bartending knowledge.

Additional purposes, features and advantages of the present invention will become apparent from the following detailed description taken in conjunction with the accompanying drawings.

### 4. BRIEF DESCRIPTIONS OF THE DRAWINGS

Although the characteristic features of this invention will be particularly pointed out in the claims, the invention itself, how it is made and how it can be used may be better understood after a review of the following description, taken in connection with the accompanying drawings wherein numeral annotations are provided throughout.

FIG. 1 shows the application of the present invention in a bartending station.

FIG. 2A shows an operation screen of the software being part of the multimedia system of the present invention.

FIG. 2B shows another operation screen of the software being part of the multimedia system of the present invention.

FIG. 2C shows another operation screen of the software being part of the multimedia system of the present invention.

FIG. 3 shows through a flow chart, the steps carried out through the bar workstation and the multimedia system being part of the present invention, with the purpose of train and support the operator.

### 5. DETAILED DESCRIPTION OF THE INVENTION

Reference is made herein to the attached drawings. Like reference, numerals are used throughout the drawings to depict like or similar tools used by the present invention with the purpose of provide training and on-job support to the bartender. The figures are intended for representative purposes only and should not be considered to be limiting in any respect.

The present invention discloses a highly technological multimedia system equipped with an independent artificial intelligence, dedicated to train bartenders, for the purpose of obtain advanced abilities in bartending and simultaneously provide to them a mental evolution, similar to the one achievable through experience. The abilities consulted in the present invention are velocity, precision, efficiency, knowledge and mind evolution due to the experience, talents obtained from the operator after the completion of the training through the present system.

As defined several times in this document, the present invention is oriented to advanced bartending training, suggesting that bartenders to train or to support should already have basic knowledge in bartending.

Together with this innovative multimedia system a new training method is disclosed, based on two different phases. In the first one highly qualified teachers will train the students, providing standardized knowledge defined by the IBA, International Bartending Association. Methods and commodities knowledge will be provided to them, as well as all the things a bartender should know, like glasses kind, pouring techniques, preparation procedures, healthy standard. In the second phase they will apply this knowledge interacting with the system disclosed in this invention, in order to improve their practical ability as bartender and to give him a mind evolution thanks to the interaction with the artificial intelligence of the present invention.

The multimedia system aforementioned results also usable in real condition of working, operating as interactive support to the expert bartender in case of requirement caused by circumstances pertinent or not to the work condition.

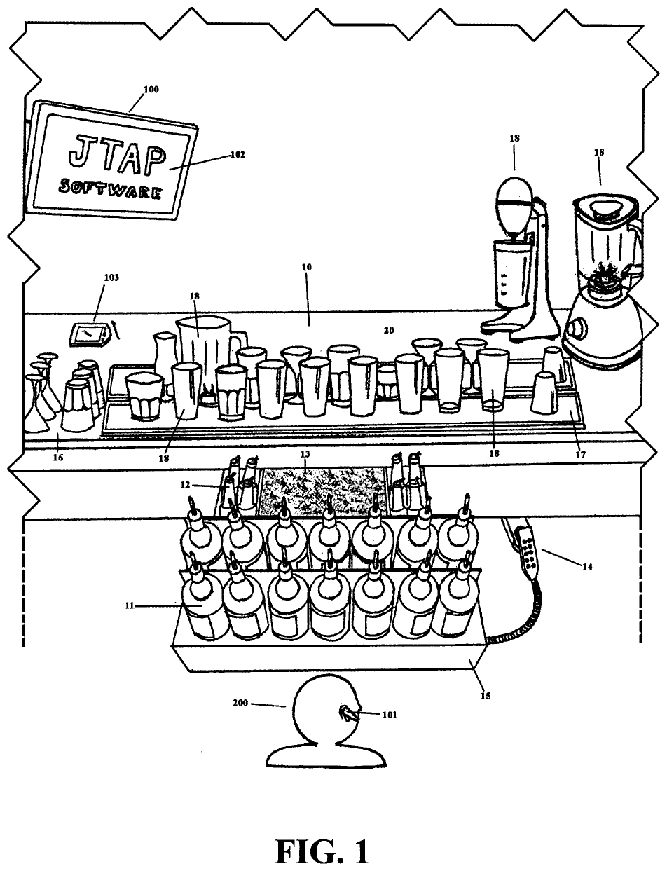

Referring now to FIG. 1, the multimedia system is composed by a personal computer connected to a flat screen 100, a Bluetooth® earphone 101, a software created from scratch 102 dedicated to the training and support, and a palmtop 103.

The personal computer is mounted on the back of the flat screen 100 and together fixed to the ceiling or to a raised point near to the workstation 10 of the bartender 200, who wears a Bluetooth® earphone 101. He will use this earphone 101 to interact with the software 102 present on the personal computer 100.

In FIG. 1 is shown a bar workstation 10, which is composed preferably by a work surface 20 with a bottles speed rack 15 with the alcoholic liquids 11, an area where accommodates the non-alcoholic products like juices 12, an ice bin 13, a soda bar gun 14, different kinds of glasses used for the service of the finished products 16, some bar mats 17 and all the tools 18 for the preparation.

The flat screen 100 and the software 102 are pointed exclusively toward the bartender position 200.

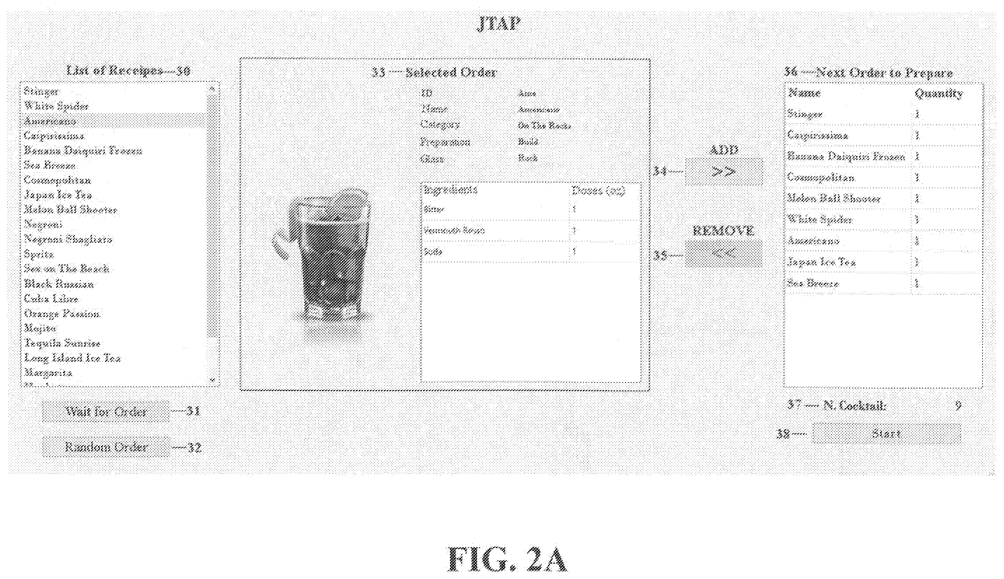

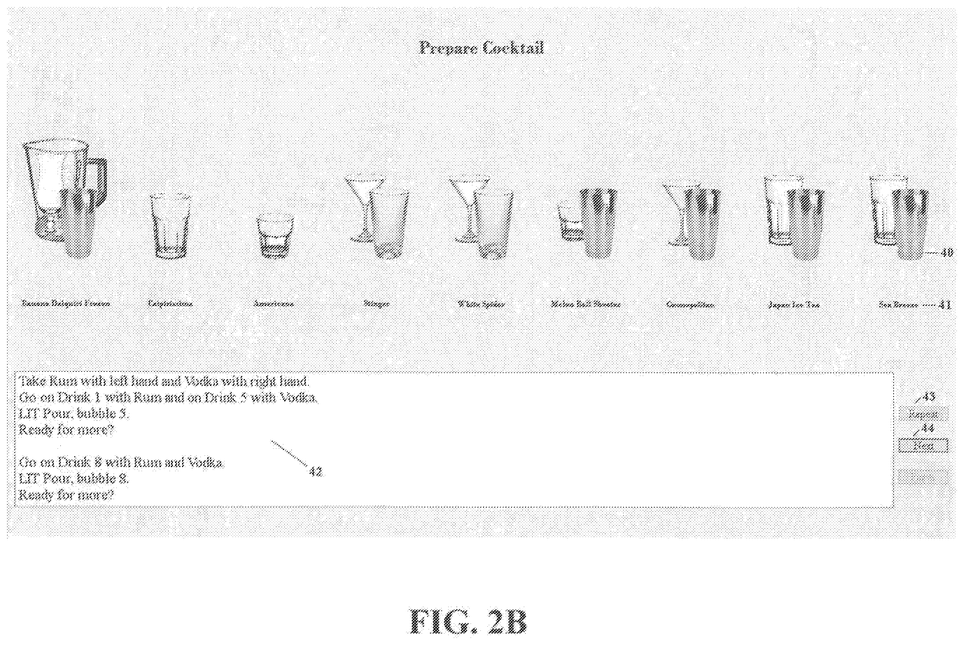

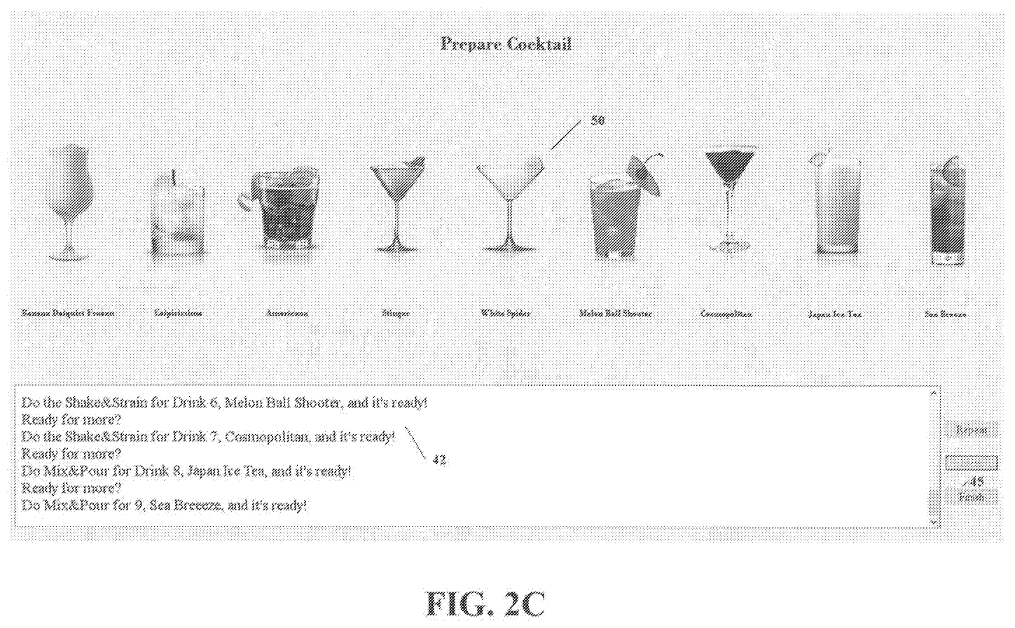

In the FIG. 2A is shown a multimedia system screen 102 useful for the interaction with the operator 200 through the employment of the flat screen 100. On the left side of the screen, there is a list of the available cocktails present in the software recipe book 30. If a cocktail is selected, different informations will be displayed 33 about it, including category, preparation technique, glass type and recipe. The button called “Add” 34 is used for insert manually a cocktail in an order to complete 36, while the button called “Remove” 35 is used for remove manually a cocktail from the order list 36. Thus, the total cocktails number is shown 37. The button “Random Order” 32 permits to casually generate a cocktails order. This function is extremely useful during the training condition, because permits to obtain cocktails lists 36 with mixed level of difficulty. Further utilizations of the button “Random Order” 32 will provide new cocktails lists 36 casually generated, and the operator could choose one of them in dependence of his abilities. It is however possible deactivate the possibility of choice, and in this way, accepting the first cocktails list 36 casually obtained. The button “Start” 38 launches the software elaboration process 102. The button “Wait for Order” 31, instead, deactivates any possible interaction on this screen and put the system in a condition of waiting for a new cocktails order, which will be provided by room staff palmtop 103. This function is instead recommended during the utilization of the system for on job support. The button “Wait for order” utilization does not need obviously the utilization of button “Start”, in that it is implied.

It's important underline that aforementioned commands are all implementable through the operator 200 voice, thanks to the utilization of the Bluetooth® earphone 101.

Through pronouncing of “Add” word with a cocktail name present in the software recipe book 30, the same operation of the button “Add” 34 will be made; then through pronouncing of “Remove” word with a cocktail name present in the cocktails list 36, the same operation of the button “Remove” 35 will be made. Through pronouncing of “Random” word, the same operation of the button “Random Order” 32 will be made. Through pronouncing of “Listen” word, the same operation of the button “Wait for Order” 31 will be made. The pronunciation of “Start” word is equivalent to press the button “Start” 38.

The button “Start” 38 will activate the independent artificial intelligence of the software 102. This intelligence is based on the operation of the genetic algorithms, so thousands combinations of preparation techniques will be created, useful to prepare the drinks order. These combinations will evolve using the crossover and mutation mechanics, and will be valuated through a fitness function. The elaboration times are about 1-2 seconds, result obtained thanks to an extremely attentive elaboration of this software section.

In FIG. 2B is shown an elaboration provided by the software 102, obtained after pressing the button “Start” 38 or through the utilization of the “Start” voice command.

An optimal arrangement for the drinks preparation is provided 40, in which glasses 16 and the equipment 18 used for the cocktails mixing are displayed. The cocktails' names 41 are also provided in this arrangement. Right after, a series of operations to be performed 42 is shown and numbers are inserted to specify the cocktail to which operations refer, with pouring techniques and doses. This series of operations 42 is reproduced through the Bluetooth® earphone 101 of the bartender 200. In this way the bartender can choose if continue to chase the instructions on the screen 100 or through the Bluetooth® earphone 101. The series of operations 42 are provided with time interruptions, to allow the bartender to perform them. A command from the bartender is required by the system after any informations, as response to the question “Ready for more?”. At this point, the bartender will have to pronounce the command “OK” through the earphone 101, to receive more instructions from the system 102. In this way, the system 102 will continue to provide instructions to the bartender 102. In case the bartender 200 have not understood part of the informations provided, he can ask the system to repeat them, by the pronunciation of the command “Repeat” through the earphone 101. In this way, the system will continue to provide the same instructions through the earphone 101. The same effect of the pronunciation of the command “OK” is obtained by the utilization of the button “Next” 44, instead, the effect of the vocal command “Repeat” is got by the utilization of the button “Repeat” 43.

In FIG. 2C is shown the final phase of the preparation. In the series of operations to perform 42, preparations techniques are provided for the completion of the cocktails, with the final indication to serve the drink. Once the preparation is completed, an image of the accomplished cocktail 50 will be shown, to prompt a possible manner of the drink presentation. At this point, the unique ways for the bartender to interact with the system will be the command “Repeat”, having finished the operations to be performed, or the command “Finish”45. This is detectable by the deactivation of the button Next” 44. The button or the vocal command “Finish” 45 will indicate to the system the completion of all operations. At this point, if the system is used for the training, the system come back to the welcome screen shown in FIG. 2A, otherwise, to the listening modality if the system is used during a work shift.

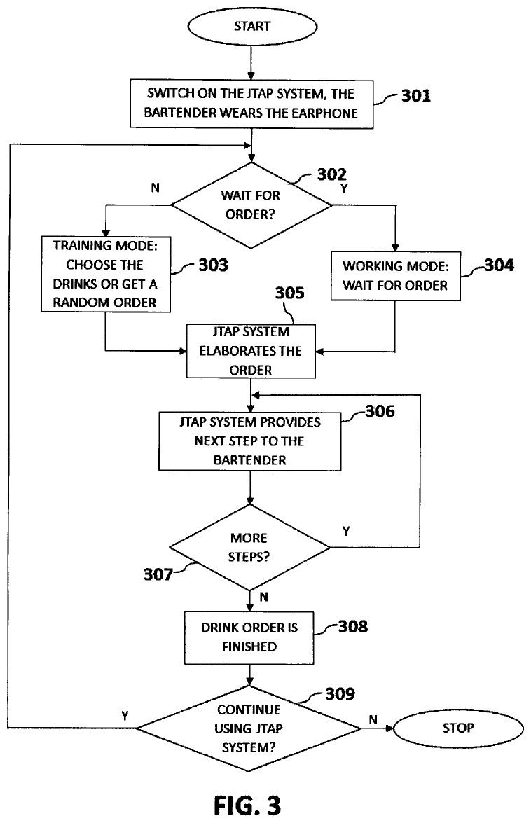

In FIG. 3 is instead shown a schematic summary of how the present invention works through using a flow chart. The system is switched on and the bartender wears the Bluetooth® earphone 301. The system can be used in training mode, choosing the cocktails to prepare or using the random function 303. If the “Wait for Order” function 302 is used, the system can be used in working mode, waiting the order from the palmtop 304.

Whatever using mode is chosen, after the system receives an order, an elaboration of the order will be made by the independent artificial intelligence 305 and instruction will be provided to the bartender 306, going on until the end of the preparation 307. When the preparation is finished 308 the system can come back to drink selection in the learning mode or in “Wait for Order” in working mode 309.

In conclusion, the present invention discloses an innovative multimedia system, dedicated to the training or on-job support in the advanced bartending, based on the genetic algorithms. This system is implemented on a bar workstation, through a personal computer with a flat screen 100 and a Bluetooth® earphone 101. The present system is endowed with a software 102 created from scratch, in which is present an independent artificial intelligence based on genetic algorithms. The bartender interacts with this system through the Bluetooth® earphone 101 and the screen 100. Recipes, ingredients doses, pouring techniques and preparation procedures are provided by visual and audio commands. The bartender is able to prepare drinks at high pace thanks to these informations, improving his practical abilities in terms of velocity, precision and efficiency.

The interaction with the independent artificial intelligence also provides to the bartender the described improvement of mind evolution, usually obtainable only with the on-job experience and, therefore, of unique and incomparable importance. The bartender's mind is molded to reason in the same way of the independent artificial intelligence, thanks to watching, listening and understanding how it works.

So, an innovative training system is defined, including two phases. In the first phase, commodity knowledge and all the preparation techniques will be provided the bartender, and in the second one, the bartender will put into practice the acquired knowledge, through the interaction with the multimedia system of the present invention, preparing of an indefinite number of drink orders with variable difficulty, passing from easier combinations to extremely challenging ones. The bartenders trained with this method will develop qualities like knowledge, velocity, precision and efficiency, and will endure a clear acceleration of their way of thinking during drinks' preparation, with the objective of reducing as much as possible the time required for the transition from apprentice to skilled bartender.

Furthermore, the multimedia system present in the present invention allow to support actively a professional bartender during his shifts, since it's perfectly capable of interact with the customers and the room staff through the utilization of the palmtop 103, which provides the real drinks orders to the software 102. The drinks orders are so elaborated by the software 102 and provided to the bartender in real time through the flat screen 100 and the Bluetooth® earphone 101. The bartender will be followed by the system during all the order preparation until its completion.

It is implied that the present invention is disclosed and described in such way to be easily understandable and realizable. However, it is right to highlight the possibility and the necessity of changes dedicated to the improvement and enhancement of the present invention. The latter can be realized through an obvious comparison with skilled in the art.

With respect to the above description then, it has to be realized regulating in the best way the dimensional relationships for the parts of the invention, to include variations in size, materials, shape, form, function and manner of operation, assembly and use. This calibration is easy to obtain for one skilled in the art. All equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multimedia system dedicated to the training of a bartender or the support during his work, comprising:
a personal computer equipped with a flat screen;
a software provided with an independent artificial intelligence, based on genetic algorithms;
a Bluetooth® earphone that is configured for communicating with the software and is used for providing information to the bartender and for obtaining instructions by him;
at least a bar workstation;
said software provided with an independent artificial intelligence, based on genetic algorithms, possesses the following features:
convert a drink's order into a human-style chromosome;
convert any drink of this order into a gene of the chromosome;
create a random population of two hundred chromosomes having the same genes of the first one but allocated in different positions;
calculate the fitness value of each chromosome using a fitness function;
select one hundred elements of the population with the highest value of fitness;
use the genetic crossover and genetic mutation to create a new population of two hundred elements;
repeat the same operations until it finds the best chromosome with the highest possible value of fitness;
reconvert the chromosome into a drink's order
provide to the bartender the chosen chromosome through the flat screen;
provide to the bartender different instruction for the preparation of the drinks through the flat screen and the Bluetooth® earphone;
obtain information or instruction by the bartender through the Bluetooth® earphone.
said bar workstation comprising:
a bar surface;
several alcoholic products;
several non-alcoholic products:
several bottles for the conservation of alcoholic and non-alcoholic products;
several glasses;
several tools necessary for the drinks preparation, like mixing tin, blender, electric mixer, mixing glasses, barmats, bar organizers, strainers and barspoons.

2. The multimedia system of claim 1, further comprising an ice bin.

3. The multimedia system of claim 1, further comprising a non-alcoholic soda products bar gun.

4. The multimedia system of claim 1, further comprising a sink and a drain.

5. The multimedia system of claim 1, wherein said personal computer equipped with a flat screen arranged on said bar surface or fixed to the ceiling near the said bar surface or in any other position near the said bar surface.

6. The multimedia system of claim 1, wherein said software provided with an independent artificial intelligence, based on genetic algorithms, is created from scratch, able to elaborate drinks orders without limit on drink's number or drink's typology, and choose the best preparation way based on a fitness function and on the mechanisms of genetic crossover and mutation.
Said fitness function is influenced by the drink's order for the following features:
number of drinks;
ingredients of each drink;
number of uses of alcoholic products;
linkage value between drinks;
glass' height for each drink;
pouring technique usable for each drink;
said genetic crossover possesses the following features:
select a portion of a first chromosome starting from the left side of it;
select a portion of a second chromosome starting from the right side of it and finishing in the same point of the other portion;
create a new chromosome using the two selected portions taken from the two chromosomes;
create a new chromosome using the two remaining portions of the two chromosomes;
said mutation possesses the following features:
select a portion of a first chromosome starting from the left side of it;
select a portion of a second chromosome starting from the right side of it and finishing in the same point of the other portion;
rotating the portion of the second chromosome referring to the middle of the portion itself;
create a new chromosome using the selected first portion and the rotated second one taken from the two chromosomes;
create a new chromosome using the two remaining portions of the two chromosomes;

7. The multimedia system of claim 1, wherein said software provided with an independent artificial intelligence, based on genetic algorithms, possesses the following features:
view a recipes book with all the drinks present in the system;
select drinks to prepare, adding them to a drink order;
deselect drinks to prepare, removing them from the drink order;
create randomly drink orders to prepare;
provide a precise disposition of glasses and tools for the preparation;
provide several guidelines like pouring techniques or preparation methods;
provide images of prepared drinks;
be able to reason on any kind of drinks, different in typology and number.

8. The multimedia system of claim 1, wherein said software provided with an independent artificial intelligence, based on genetic algorithms, possesses the following operations:
view on a flat screen the operation to perform;
listen through a Bluetooth® earphone the command about operations to perform;
make selections on the system through voice commands;
request informations to the system through voice commands.

9. A new training method for bartenders comprising:
One or more students who work on a bar workstation comprising:
a bar surface;
several alcoholic products;
several non-alcoholic products:
several bottles for the conservation of alcoholic and non-alcoholic products;
several glasses;
several tools necessary for the drinks preparation, like mixing tin, blender, electric mixer, mixing glasses, bar mats, bar organizers, strainers and bar spoons;
the multimedia system of claim 1;
inputting a drink's order into the software provided with an independent artificial intelligence, based on genetic algorithms or creating it randomly by the software;
elaborating the drink's order through the software provided with an independent artificial intelligence, based on genetic algorithms;
providing to said students commodity and preparation methods knowledge with a classic approach;
providing to said students recipes and ingredients doses of drinks through the multimedia system of claim 1;
providing to said students pouring techniques and preparation procedures necessary for the preparation of a drink order through the flat screen of the multimedia system of claim 1;
providing to said students pouring techniques and preparation procedures necessary for the preparation of a drink order through the earphone of the multimedia system of claim 1;
driving said students until the completion of all the drinks present in the order;
repeating the preparation path followed by the multimedia system of claim 1, for an indefinite number of times, varying the difficulty of the drink orders based on the bartender abilities.

10. A new method to support the bartender during a real shift comprising:
a professional bartender who works on a bar workstation comprising:
a bar surface;
several alcoholic products;
several non-alcoholic products:
several bottles for the conservation of alcoholic and non-alcoholic products;
several glasses;
several tools necessary for the drinks preparation, like mixing tin, blender, electric mixer, mixing glasses, barmats, bar organizers, strainers and barspoons;
the multimedia system of claim 1;
a palmtop dedicated to obtain drink orders;
setting up the software of the multimedia system of claim 1 in modality to receive orders from palmtop;
providing the software of the multimedia system of claim 1 with a drink order from customers through the palmtop used by the room staff;
elaborating the drink's order through the software provided with an independent artificial intelligence, based on genetic algorithms;
providing to the bartender pouring techniques and preparation procedures necessary for the preparation of a drink order received by the palmtop, through the flat screen of the multimedia system of claim 1;
providing to the bartender pouring techniques and preparation procedures necessary for the preparation of a drink order received by the palmtop, through the earphone of the multimedia system of claim 1;
driving said professional bartender until the completion of all drinks present in the order.
